(19) United States
(12) Patent Application Publication
(10) Pub. No.: US 2023/0318114 A1
(43) Pub. Date: Oct. 5, 2023

(54) BATTERY MODULE AND DISASSEMBLING METHOD THEREOF

(71) Applicant: HONDA MOTOR CO., LTD., Tokyo (JP)

(72) Inventors: Takuya Taniuchi, Wako-shi (JP); Toshiyuki Ariga, Wako-shi (JP)

(21) Appl. No.: 18/126,507

(22) Filed: Mar. 27, 2023

(30) Foreign Application Priority Data
Mar. 31, 2022 (JP) 2022-057985

(51) Int. Cl. H01M 50/264; H01M 50/209; H01M 50/293; H01M 10/613

(52) U.S. Cl. CPC H01M 50/264; H01M 50/209; H01M 50/293; H01M 10/613

(57) ABSTRACT

A battery module of the present invention includes a plurality of stacked solid battery cells, end plates disposed at one end and other end of the plurality of solid battery cells in the stacking direction, respectively, a constraint part configured to press against the plurality of solid battery cells from both ends via the end plates and constrain the plurality of solid battery cells, a separator disposed at least at one of between the plurality of solid battery cells and between the solid battery cells and the end plates, and a strut member installed between the end plates, a thermal expansion coefficient of the separator being greater than a thermal expansion coefficient of the solid battery cells.

### CROSS-REFERENCE TO RELATED APPLICATION

Priority is claimed on Japanese Patent Application No. 2022-057985, filed Mar. 31, 2022, the content of which is incorporated herein by reference.

### BACKGROUND OF THE INVENTION

### Field of the Invention

The present invention relates to a battery module and a disassembling method thereof.

### Description of Related Art

In recent years, in order to ensure access to affordable, reliable, sustainable and advanced energy for more people, research and development have been carried out on secondary batteries that contribute to energy efficiency. In a battery module that constitutes a general electronic instrument such as a mobile phone, a digital camera, a laptop computer, or the like, a plurality of secondary battery cells are mounted in a battery pack type in which they are constrained while overlapping between a pair of end plates.

In the battery pack in which the secondary battery cells are mounted, there are the following issues. In the battery pack, in order to prevent a position shift of the battery cells due to vibrations, an impact, or the like, a high pressure is applied to the secondary battery cells via a constraint mechanism. When the battery pack is disassembled, since the high pressure is abruptly released, the constraint mechanism may be damaged by the impact, and fragments of the constraint mechanism, constrained battery cells, and the like may be scattered around violently.

Japanese Unexamined Patent Application, First Publication No. 2019-125444 discloses a method of disassembling a battery pack in a state in which abrupt release of a constraint pressure is suppressed by slowly pulling one end plate and extending a constraint distance of battery cells in a state in which the battery pack is fixed.

### SUMMARY OF THE INVENTION

However, it is assumed that some of the secondary battery cells installed in the battery pack are degraded and expansion amounts of each of the secondary battery cells do not match. In the disassembling method disclosed in Japanese Unexamined Patent Application, First Publication No. 2019-125444, it is difficult to adjust a tensile strength of the end plate according to an expansion amount of each of the secondary battery cells.

In addition, a constraint distance of the solid battery cells can be extended by only a range of an elastic region of a member that pulls the end plates, and it is difficult to extend the constraint distance when the solid battery cells contain an active material with a large volume expansion such as Li or Si.

An aspect of the present invention is directed to providing a battery module and a disassembling method thereof that enable solid battery cells to be easily removed in a state in which a variation in constraint pressure is suppressed. Further, an aspect of the present invention is to contribute to energy efficiency.

An aspect of the present invention employs the following configurations.
(1) A battery module according to an aspect of the present invention includes a plurality of stacked solid battery cells; a first end plate and a second end plate disposed at one end and other end of the plurality of solid battery cells in a stacking direction, respectively, so as to face each other; a constraint part configured to press against the plurality of solid battery cells from both ends via the first end plate and the second end plate and configured to constrain the plurality of solid battery cells; a separator disposed at least at one location among a location between the plurality of solid battery cells, a location between the solid battery cells and the first end plate and a location between the solid battery cells and the second end plate; and a strut member installed between the first end plate and the second end plate, a thermal expansion coefficient of the separator being greater than a thermal expansion coefficient of the solid battery cells.

According to this configuration, only the separator can be relatively greatly shrunk between the first end plate and the second end plate by the cooling, and a density in the stacking direction can be decreased. As a result, a constraint force with respect to the solid battery cells can be attenuated while maintaining the constraint force of the entire battery module. Accordingly, attachment and removal of the solid battery cells 101 can be easily performed in a state in which a change in constraint pressure is suppressed, and the disassembly thereof can be easily performed while avoiding damage or the like to the constraint mechanism.
(2) In the battery module according to the above-mentioned (1), the thermal expansion coefficient of the separator may be 10 times or more and 100 times or less the thermal expansion coefficient (considering the battery as a metal material) of the solid battery cells.

According to this configuration, since only the separator can be shrunk in a state in which a shape of the solid battery cells is substantially maintained, it is possible to reduce damage to the solid battery cells according to the shrinkage.
(3) In the battery module according to the above-mentioned (1) or (2), in the separator, a thermal expansion coefficient of a side of one end may be greater than a thermal expansion coefficient on opposite side.

According to this configuration, when the separators (104) are cooled, one end side where the solid battery cells (101) are put in and taken out relatively easily shrinks, and an opposite side shrinks less easily. For this reason, by adjusting the cooling temperature, for example, it is possible to realize a state in which a portion of the separator (104) on the side of one end is separated from the solid battery cells (101) to an extent of shrinkage and an opposite portion comes into contact with the solid battery cells (101). Accordingly, the solid battery cells can be easily pulled out because a contact area with the separator is reduced.
(4) In the battery module according to any one of the above-mentioned (1) to (3), the strut member may have an expansion mechanism that expands and contracts at a predetermined ratio in the stacking direction.

According to this configuration, a distance between the first end plate and the second end plate can be finely adjusted according to a thermal expansion amount of the battery cells, and a constraint force with respect to the battery cells can be optimized.
(5) In the battery module according to any one of claims (1) to (4), in a direction perpendicular to the stacking direction, a plurality of strut members may be installed so as to face each other while having the solid battery cells sandwiched therebetween.

According to this configuration, a force against the constraint force is increased by increasing the number of the installed strut members, and the distance between the first end plate and the second end plate can be held more stably.
(6) A disassembling method of the battery module according to the aspect of the present invention is the disassembling method of the battery module according to any one of the above-mentioned (1) to (5), the disassembling method of the battery module having: a process of cooling the battery module; and a process of separating the solid battery cells from the cooled battery module.

According to this configuration, a state in which the constraint with respect to the solid battery cells is attenuated can be realized by the shrinkage of the cooled separator. For this reason, the predetermined solid battery cells can be easily removed without exerting an influence on disposition of the other solid battery cells, separators, and the like.
(7) In the disassembling method of the battery module according to the above-mentioned (6), in the process of cooling the battery module, among the battery module, the separator adjacent to the solid battery cell to be removed may be cooled.

According to this configuration, it is possible to remove only the predetermined battery that has been cooled locally, and prevent the other battery cells from being unnecessarily removed.

According to the aspect of the present invention, it is possible to provide the battery module and the disassembling method thereof that enable the solid battery cells to be removed in a state in which a change in constraint pressure is suppressed, which in turn contributes to energy efficiency.

### BRIEF DESCRIPTION OF THE DRAWINGS

FIG. 1A is a plan view of a battery module according to an embodiment of the present invention.

FIG. 1B is a cross-sectional view of the battery module according to the embodiment of the present invention.

FIG. 2 is a view for describing a process of removing solid battery cells in the battery module of the same embodiment.

FIG. 3 is a cross-sectional view of a battery module according to Variant 1 of the same embodiment.

FIG. 4 is a cross-sectional view of a battery module according to Variant 2 of the same embodiment.

### DETAILED DESCRIPTION OF THE INVENTION

Hereinafter, a battery module, and a removal method and an attachment method of solid battery cells according to an embodiment to which the present invention is applied will be described in detail with reference to the accompanying drawings. Further, in the drawings used in the following description, in order to make features easier to understand, characteristic parts may be shown enlarged for convenience, and dimensional ratios of components may not necessarily be the same as the actual ones. In addition, materials, dimensions, and the like illustrated in the following description are examples that do not limit the present invention, and it is possible to execute them with appropriate changes without departing from the scope of the present invention.

### <Battery Module>

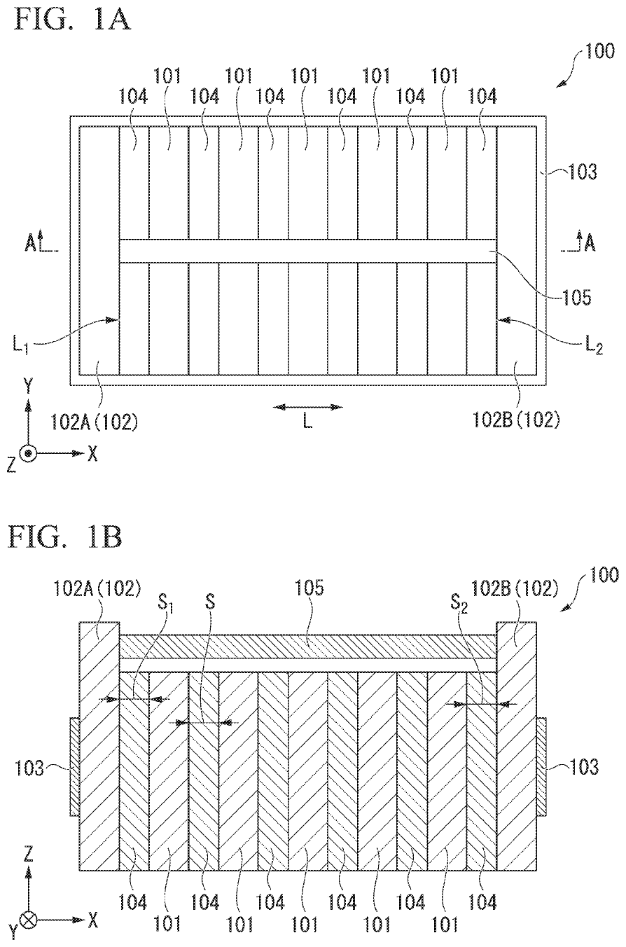

FIG. 1A is a plan view of a battery module 100 according to an embodiment of the present invention. FIG. 1B is a cross-sectional view of the battery module 100 of FIG. 1A along line A-A. The battery module 100 mainly includes a plurality of solid battery cells 101, a pair of end plates 102 (a first end plate 102A, a second end plate 102B), a constraint part 103, separators 104, and a strut member 105.

The plurality of solid battery cells 101 each include a positive electrode current collector, a positive electrode active material, a solid electrolyte, a negative electrode active material, and a negative electrode current collector, which are stacked while overlapping directly or with another member sandwiched therebetween in one direction (here, an X direction).

In the pair of end plates 102, the first end plate 102A on one side is disposed to come into contact with one end L₁ of the solid battery cells 101 in a stacking direction L, and the second end plate 102B on the other side is disposed to come into contact with the other end L₂ in the same stacking direction.

The constraint part 103 is pressed against the plurality of solid battery cells 101 from both ends L₁ and L₂ via the first end plate 102A and the second end plate 102B in the stacking direction and has a function of constraining all the solid battery cells 101. Here, while a band-shaped member (a constraint hoop or the like) that surrounds all the stacked solid battery cells 101 is exemplified as the constraint part 103, it may be replaced with another type.

The separators 104 are disposed in at least one of a gap S between the plurality of solid battery cells 101, a gap S₁ between the solid battery cells 101 and the first end plate 102A and a gap S₂ between the solid battery cells 101 and the second end plate 102B. In FIG. 1A and FIG. 1B, while a case in which the separators 104 are disposed in all the gaps has been exemplified, the separators 104 may not be disposed in some of the gaps according to the application. For example, when attachment and removal of the plurality of solid battery cells 101 are performed simultaneously, the separators 104 may not be disposed in the gap S between these solid battery cells.

A thermal expansion coefficient of the separators 104 is greater than a thermal expansion coefficient of the solid battery cells 101, and preferably, at least 10 times or more the thermal expansion coefficient of the solid battery cells 101 (considering the battery as a metal material). From a practical point of view, the expected thermal expansion coefficient of the separators 104 is equal to or smaller than 100 times the thermal expansion coefficient of the solid battery cells 101. Further, the thermal expansion coefficient of the solid battery cells 101 in the embodiment means a value obtained by summing thermal expansion coefficients of all components such as electrode members, current collectors, and the like, that constitute the solid battery cells 101.

While a material of the separators 104 is not particularly limited, from a practical point of view, a material compressed by about 1 to 5%, i.e., a material with a thermal expansion coefficient of 6×10⁻⁶ or more and 25×10⁻⁶ (1/K) or less is preferable when cooled from a room temperature (about 20 to 30° C.) to −100° C. or less (−198° C. under liquid nitrogen). As such a material, for example, a resin material such as polyvinylchloride (PVC), polyethylene (LDPE), polypropylene (PP), or the like, is exemplified.

In a case in which the separators 104 are formed of a single material, when the battery module 100 is cooled, all the separators 104 shrink uniformly. However, from the viewpoint of weakening the constraint on the solid battery cells 101, at least some of the separators 104 may shrink or may not shrink. That is, the separators 104 are may be constituted by a plurality of members with different thermal expansion coefficients.

As the above-mentioned separators 104, for example, a structure in which a member with a large thermal expansion coefficient and a member with a small thermal expansion coefficient are stacked in the stacking direction L of the solid battery cells 101 is exemplified. For example, if a member having high resistivity is used for the member having a small thermal expansion coefficient, a separator 104 in which both of the thermal expansion characteristics and insulation are increased as a whole can be obtained.

The strut member (strut mechanism) 105 is installed between the first end plate 102A and the second end plate 102B, and has a function of maintaining a distance therebetween at an initial temperature (for example, a room temperature). That is, the strut member 105 is formed of a material having hardness that can endure a pressing force due to the constraint part 103 and a material having a thermal expansion coefficient that is remarkably smaller than that of another component (equal to or smaller than about a half thereof). As the material of the strut member 105, for example, Ti alloy, invar alloy (36% Ni steel), or the like, is exemplified. Since the strut member 105 is installed, when some or all of the solid battery cells 101 are removed, it is possible to prevent the pressing force on the solid battery cells 101 from increasing due to the constraint part 103.

Further, while a bind bar or the like, in addition to the strut member 105, may be installed between the first end plate 102A and the second end plate 102B, a material of the bind bar generally has a large thermal expansion coefficient. For this reason, even when the bind bar is installed, there is a need to install the strut member 105.

In FIG. 1A and FIG. 1B, while a case in which the strut member 105 is a rod-shaped member extending in one direction is exemplified, a shape of the strut member 105 is not limited thereto and may be, for example, a plate shape, a block shape, or another shape.

The strut member 105 may have a function (expansion mechanism) of expanding and contracting at a predetermined ratio such that the mounted solid battery cells 101 are not damaged in an extension direction (here, the stacking direction L). Here, a distance between the first end plate 102A and the second end plate 102B can be finely adjusted according to the thermal expansion amount of the solid battery cells 101, and a constraint force with respect to the solid battery cells 101 can be optimized.

### <Removal Method of Solid Battery Cells>

According to the battery module 100 of the embodiment, the solid battery cells 101 can be removed mainly through the following processes (an A1 process, an A2 process).

### (A1 Process)

The battery module 100 is cooled using a cooling means. As an inexpensive and suitable cooling means, for example, a means configured to immerse and freeze the battery module 100 in an extremely low temperature insulating liquid such as liquid nitrogen or the like is exemplified. While the cooling temperature is not limited, it is preferable to be set to a function guarantee temperature or less (for example, −40° C. or less) of the material of the separators 104. For example, the material of the separators 104 is preferably cooled to −100 to −198° C. when it is a resin such as PVC, PE, PP, or the like.

A temperature drop rate during cooling is preferably about a rate at which the members in contact with the separators 104 could not follow, and preferably about a rate at which an impact is not applied to the same member, and from a practical point of view, it is assumed within a range of about −10° C./min or more and −30° C./min or less. For example, when a means of immersing in the liquid nitrogen is used, the whole is cooled while adding the liquid nitrogen in consideration of a thermal capacity of a module or a cell and the amount of vaporization of the liquid nitrogen.

The solid battery cells 101 and the separators 104 contract at a rate corresponding to the thermal expansion coefficient thereof by this cooling. The separators 104 shrinks more greatly than the solid battery cells due to a difference in thermal expansion coefficient, and a constraint force applied to the solid battery cells 101 via the separators 104 in the stacking direction L is attenuated. In particular, a constraint force with respect to the solid battery cells 101 in the vicinity of the shrunk separators 104 is greatly attenuated. The constraint force with respect to the solid battery cells 101 in the vicinity of the shrunk separators 104 is most greatly attenuated. The shrinkage of the separators 104 can be increased as the cooling temperature is lowered, and as a result, gaps may be created between the shrunk separators 104 and the adjacent solid battery cells 101.

Further, since the distance between the first end plate 102A and the second end plate 102B is maintained in the initial temperature (for example, room temperature) state by the strut member 105, a new pressing force of the constraint part 103 that cancels the attenuation of the constraint force is not added.

### (A2 Process)

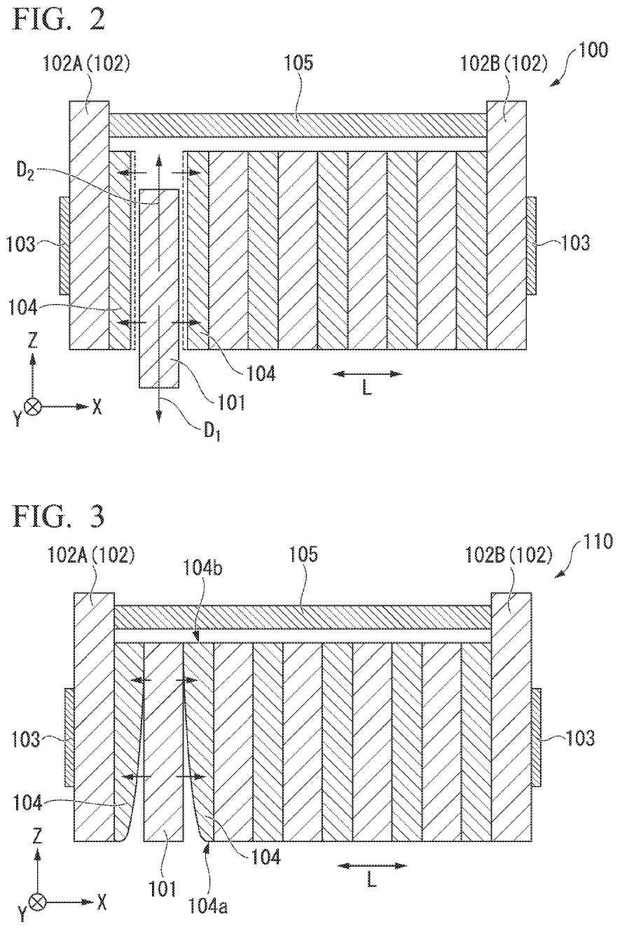

FIG. 2 is a view for describing a process of performing attachment and removal of the solid battery cells 101 in the battery module 100 of the embodiment. As shown by a down arrow Di in FIG. 2, the solid battery cell 101 adjacent to the shrunk separator 104 or the solid battery cell 101 in the vicinity of the shrunk separator 104 is pulled and separated from the battery module 100 in one direction (here, a −Z direction). While the pulling direction is not particularly limited, it is preferably pulled toward a side where the strut member 105 is not installed. The solid battery cell 101 whose constraint is attenuated can be easily removed without exerting an influence on disposition of the other solid battery cells 101, separators 104, and the like, in the pulling process.

As the cooling method of the A1 process, the entire battery module 100 may be cooled uniformly, and a portion in the vicinity of the separator 104 adjacent to the removed solid battery cell 101 may be cooled locally. For example, when the separator 104 adjacent to the solid battery cell 101 that is removed and attached is set as a first layer, it is preferable to locally cool the area up to the separator 104 corresponding to a third layer, and it is more preferably to restrictively cool only the separator 104 of the first layer. Since such local cooling is performed, removal and attachment of a predetermined battery only becomes possible, and it is possible to prevent the other battery cells from being unnecessarily removed.

As described above, the battery module 100 of the embodiment includes the separators 104 with a large thermal expansion coefficient between the stacked solid battery cells 101, and includes the strut member 105 located between the end plates 102 on both ends and configured to maintain a distance between the end plates 102. For this reason, by the cooling, it is possible to make only the separators 104 between the end plates 102 relatively greatly shrunk and to decrease a density in the stacking direction, and the constraint force with respect to the solid battery cells 101 can be attenuated while maintaining the constraint force of the entire battery module 100. Therefore, according to the battery module 100 of the embodiment, attachment and removal of the solid battery cells 101 can be easily performed in a state in which a change in constraint pressure is suppressed, and the disassembly thereof can be easily performed while avoiding problems such as damages on the constraint mechanism.

FIG. 3 is a cross-sectional view of a battery module 110 according to Variant 1 of the embodiment. For the battery module 110, in the separators 104, a thermal expansion coefficient on the side of one end 104a (a −Z side) where the solid battery cells 101 enter is greater than a thermal expansion coefficient on the side of the other end 104b (a +Z side) opposite thereto. Another configuration of the battery module 110 is the same as the battery module 100 and exhibits at least the same effect as the battery module 100. In addition, a place corresponding to the battery module 100 is designated by the same reference sign.

When the separators 104 are cooled, relatively, one end side where the solid battery cells 101 enter easily shrinks, and the opposite side is less likely to shrink. For this reason, by adjusting the cooling temperature, it is possible to realize a state in which, for example, a portion of the separator 104 on the side of one end is separated from the solid battery cell 101 to a shrunk extent and an opposite portion comes into contact with the solid battery cell 101. Accordingly, the solid battery cells 101 can be easily pulled to an extent that the contact area with the solid battery cells 101 is smaller than the separators 104 of the battery module 100. In addition, in the pulling process, influence on disposition of the other solid battery cells 101, separators 104, and the like, can be reduced.

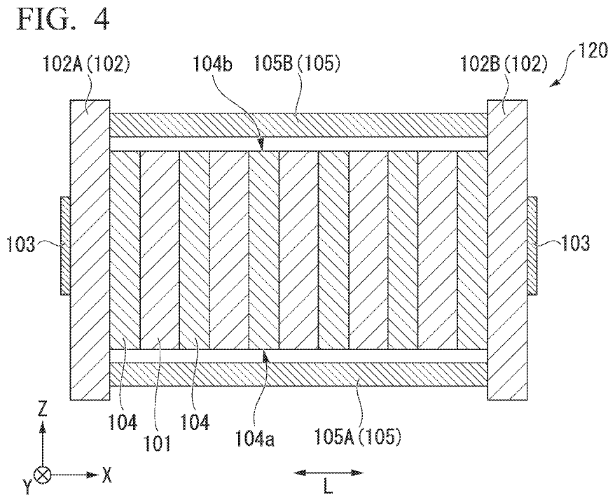

FIG. 4 is a cross-sectional view of a battery module 120 according to Variant 2 of the embodiment. In the battery module 120, a plurality of strut members 105 are disposed between the first end plate 102A and the second end plate 102B. The plurality of strut members 105 are installed to face each other with the solid battery cells 101 sandwiched therebetween in a direction perpendicular to the stacking direction L. Here, a case in which the two strut members 105 (105A, 105B) are installed is exemplified. One strut member 105A is installed at a position opposite to the side of one end 104a (a −Z side) of the separator, and the other strut member 105B is installed at a position opposite to the side of the other end 104b (a +Z side) of the separator. Another configuration of the battery module 120 is the same as the battery module 100 and exhibits at least the same effect as the battery module 100. In addition, a place corresponding to the battery module 100 is designated by the same reference sign.

Since a force (holding force) against the constraint force is increased by increasing the number of the installed strut members 105, the distance between the first end plate 102A and the second end plate 102B can be held more stably. From the viewpoint of stabilizing the holding force, it is preferable that the number of the installed strut members 105 becomes larger, and a size (thickness) in a width direction (YZ direction) perpendicular to the extension direction (here, the X direction) of the strut member 105 becomes larger.

In addition, from the same viewpoint, the installed strut members 105 are preferably disposed symmetrically in the stacking direction L of the solid battery cells 101 using a centerline C passing through a center (center of gravity) of the solid battery cells 101 as an axis. However, when the strut member 105 is installed in the entire region that surrounds the centerline C, since it is difficult to put the solid battery cells 101 in and out, it is preferable to provide at least one area where the strut member 105 is not installed.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A battery module comprising:
a plurality of stacked solid battery cells;
a first end plate and a second end plate disposed at one end and other end of the plurality of solid battery cells in a stacking direction, respectively, so as to face each other;
a constraint part configured to press against the plurality of solid battery cells from both ends via the first end plate and the second end plate and configured to constrain the plurality of solid battery cells;
a separator disposed at least at one location among a location between the plurality of solid battery cells, a location between the solid battery cells and the first end plate and a location between the solid battery cells and the second end plate; and
a strut member installed between the first end plate and the second end plate,
wherein a thermal expansion coefficient of the separator is greater than a thermal expansion coefficient of the solid battery cells.

2. The battery module according to claim 1, wherein the thermal expansion coefficient of the separator is 10 times or more and 100 times or less the thermal expansion coefficient of the solid battery cells.

3. The battery module according to claim 1, wherein, in the separator, a thermal expansion coefficient of a side of one end is greater than a thermal expansion coefficient on opposite side.

4. The battery module according to claim 1, wherein the strut member has an expansion mechanism that expands and contracts at a predetermined ratio in the stacking direction.

5. The battery module according to claim 1, wherein, in a direction perpendicular to the stacking direction, a plurality of strut members are installed so as to face each other while having the solid battery cells sandwiched therebetween.

6. A disassembling method of the battery module according to claim 1, the disassembling method of the battery module including:
a process of cooling the battery module; and
a process of separating the solid battery cells from the cooled battery module.

7. The disassembling method of the battery module according to claim 6, wherein, in the process of cooling the battery module, among the battery module, the separator adjacent to the solid battery cell to be removed is cooled.
